(19) United States
(12) Patent Application Publication
(10) Pub. No.: US 2012/0020836 A1
(43) Pub. Date: Jan. 26, 2012

(54) PIPETTING NOZZLE FOR AUTOANALYZER, METHOD FOR PRODUCING SAME AND AUTOANALYZER USING SAME

(76) Inventors: Akihiro Nojima, Yokohama (JP); Shinichi Taniguchi, Tokyo (JP); Takashi Inoue, Yokohama (JP); Hiroaki Ishizawa, Hitachinaka (JP)

(21) Appl. No.: 13/147,168

(22) PCT Filed: Jan. 5, 2010
(86) PCT No.: PCT/JP2010/050016

§ 371 Date: Oct. 10, 2011

(30) Foreign Application Priority Data
Mar. 27, 2009 (JP) 2009-080346

(51) Int. Cl. G01N 30/00; C25D 3/48; C25D 5/48; B05D 3/06

(52) U.S. Cl. 422/69; 427/553; 205/266

(57) ABSTRACT

In an autoanalyzer for analyzing samples, such as urine and blood, analytical and measured values are prevented from being affected by carry-over caused by the repeated use of a pipetting nozzle. A molecular layer for inhibiting the adsorption of biological polymers is formed by coating surfaces of the pipetting nozzle with a polyethylene glycol derivative chemisorbed thereto, thereby reducing carry-over caused by the pipetting nozzle.

### TECHNICAL FIELD

The present invention relates to a pipetting nozzle for autoanalyzers, a method for manufacturing the pipetting nozzle, and an autoanalyzer equipped with the pipetting nozzle.

### BACKGROUND ART

In a clinical examination for medical diagnosis, biochemical analysis and immunological analysis are performed on protein, sugar, lipid, enzyme, hormone, inorganic ions, disease markers, and the like in a biological sample, such as blood and urine. Since a plurality of inspection items needs to be processed with high reliability and at high speed in a clinical examination, most of the items are processed using an autoanalyzer. As the autoanalyzer, there has been known, for example, a biochemical autoanalyzer in which a reaction liquid prepared by mixing a desired reagent into a sample, such as blood serum, and reacting the reagent with the sample is used as an object of analysis to conduct biochemical analysis by measuring the absorbance of the reaction liquid. This type of biochemical autoanalyzer is provided with a container for storing samples and reagents, a reaction cell into which a sample and a reagent are injected, a pipetting mechanism for automatically injecting a sample and a reagent into the reaction cell, an automatic agitating mechanism for mixing the sample and the reagent within the reaction cell, a mechanism for measuring the absorbance of a sample the reaction of which is in progress or completed, an automatic cleaning mechanism for suctioning and discharging a reaction liquid after the completion of measurement to clean the reaction cell, and the like (see, for example, Patent Literature 1).

In such an autoanalyzer, multitudes of samples and reagents are generally dispensed in succession by using a pipetting nozzle. For example, a sample pipetting nozzle batches off a predetermined amount of sample from a container, such as a blood sampling tube, in which the sample is stored, discharges the sample into a reaction cell in which a reagent is reacted with the sample. A reagent pipetting nozzle discharges a predetermined amount of reagent batched off from a container in which the reagent is stored into a sample reaction cell. At this time, adverse effects may be caused on measurement results if constituents of a dispensed liquid remaining on surfaces of a pipetting nozzle get mixed in with the next dispensed liquid. This is referred to as carry-over.

The problem of carry-over is deeply linked to the recent demand for reductions in the amounts of samples and reagents in the field of autoanalyzers. An amount of sample that can be allocated to a single item is reduced as the number of analysis items increases. In some cases, the sample itself is valuable, and therefore, cannot be prepared in large amounts. Thus, there is also a demand for higher analytical sensitivity. In addition, reagents generally tend to be costly as the details of analysis become increasingly sophisticated. Thus, there is a demand for a reduction in the amounts of reagents also from the viewpoint of costs. In response to such a growing demand for reductions in the amounts of samples and reagents, pipetting nozzles have become increasingly small in diameter. Consequently, the outer tube diameter of a nozzle has been decreased to approximately 0.5 mm. A reduction in the tube diameter causes an increase in a ratio of the surface area to the volume of a solution to be dispensed. Accordingly, it has become increasingly important to control adsorption of substances onto surfaces of the pipetting nozzle and reduce carry-over.

In addition, when samples for the analysis of biochemical items and immunological items the concentration measurement range of which is wider are collected from the same container and measured, sample-to-sample carry-over by a pipetting nozzle is required to be reduced as much as possible.

As a method for reducing carry-over, there has been conventionally practiced cleaning using a detergent containing pure water and a surfactant (Patent Literature 2). It is difficult in some cases, however, to clean off biological polymers as typified by protein by using such a method. Other methods include deactivating attached residues of samples by active oxygen. However, the deactivated residues of samples accumulate on a nozzle surface in this method, and therefore, a pipetting nozzle cannot endure a long period of use (Patent Literature 3).

A method of using a throw-away disposable nozzle (disposable tip) is also known as one of solutions to carry-over. It is difficult, however, to form the disposable nozzle into a fine structure from the viewpoint of strength and machining accuracy. In addition, use of disposable nozzles has the problem of producing massive amounts of waste and increasing environmental burdens.

XPS (X-ray photoelectron spectroscopy) or the like is widely used for the quantification and composition analysis of chemical substances adsorbed onto a surface. For example, analysis is conducted on the composition of monomolecular films, such as a self-assembled monolayer, and the quantification of chemical species (Non-Patent Literatures 1 and 2). Similarly, it is possible to quantify protein remaining on a surface by XPS (Non-Patent Literature 3).

### CITATION LIST

### Patent Literature

Patent Literature 1: JP Patent No. 1706358

Patent Literature 2: JP 2007-85930 A

Patent Literature 3: JP Patent No. 3330579

### Non-Patent Literature

Non-Patent Literature 1: Chemical Reviews, 96, pp. 1533-1554 (1996)

Non-Patent Literature 2: Journal of the American Chemical Society, 115, pp. 10714-10721 (1993)

Non-Patent Literature 3: The Journal of Physical Chemistry B, 107, pp. 6766-6773 (2003)

### SUMMARY OF INVENTION

### Technical Problem

Analytical components of analysis items for which it is highly necessary to avoid carry-over are often biological polymers, such as protein. Accordingly, inhibiting biological polymers, such as protein, from remaining on surfaces of a pipetting nozzle is a solution for the reduction of carry-over.

An object of the present invention is to provide a pipetting nozzle for an autoanalyzer designed to upgrade surface cleanness without the use of a disposable nozzle and reduce carry-over, and an autoanalyzer using the pipetting nozzle.

### Solution to Problem

The adsorption of polymers, such as protein, derived from a biological body is inhibited by chemisorbing and coating a polyethylene glycol derivative onto surfaces of a pipetting nozzle, thereby achieving the aforementioned object. Here, chemisorption refers to a mode of adsorption due to chemical bonds, such as a covalent bond and an ion bond, on a solid surface having a heat of adsorption of approximately 20 to 100 kcal/mol. Chemisorption is distinguished from physisorption in which Van der Waals's force the heat of adsorption of which is normally 10 kcal/mol or less is used as a bonding force. Polyethylene glycol is hydrophilic and, for reasons of the steric repulsive force thereof, holds promise of being effective in inhibiting the adsorption of biological polymers, such as protein.

Due to the requirement that the necessary number of ethylene oxide groups is 2 or greater and molecular interaction for molecules to become arrayed is sufficient, the number average molecular weight of the polyethylene glycol derivative is desirably 100 or higher. Conversely, if the intermolecular steric repulsive force is too strong, the amount of polyethylene glycol derivative adsorbed onto a surface reduces. Accordingly, the number average molecular weight of the polyethylene glycol derivative is desirably 20000 or lower. The chemical structure of the polyethylene glycol derivative to coat surfaces with need not necessarily be a unitary structure but may be an intermixture.

FIG. 1 illustrates a schematic view of a pipetting nozzle. As a material high in resistance to corrosion and superior in machinability, stainless steel is widely used for a pipetting nozzle main unit 101. The pipetting nozzle is bent at a portion 102 and connected to a suction mechanism. At the time of suctioning a sample or a reagent, the pipetting nozzle suctions a predetermined amount of the sample or reagent into a hollow portion 103. At the time of dispensation, outer surfaces of the pipetting nozzle are also immersed in the sample or reagent. Accordingly, areas where the polyethylene glycol derivative is chemisorbed and coated are an edge portion 105 and the outer surfaces. In addition, these areas are sufficiently larger than an area 104 immersed in the sample or reagent when the pipetting nozzle dispenses the sample or reagent. Inner surfaces of the pipetting nozzle may also be treated, if possible.

As a method for chemisorbing the polyethylene glycol derivative onto surfaces of the pipetting nozzle, it is conceivable to immobilize molecules by the chemical bonding of sulfur and metal by using such a polyethylene glycol derivative having a thiol group at one terminal thereof as shown in General Formula 1.

HS—R₁—(OCH₂CH₂)ₙ—O—R₂ (General Formula 1)

(n is a positive integer equal to or larger than 2, R₁ is a hydrocarbon group, and R₂ is H or CH₃)

As described earlier, stainless steel is widely used for the pipetting nozzle of an autoanalyzer from the viewpoint of excellent machinability and corrosion resistance. It is difficult, however, for sulfur atoms to directly form chemical bonds in stainless steel. As a method for solving this problem, the inventors have conceived of a method for forming a gold thin-film layer on a surface of a pipetting nozzle by means of electroplating or electroless plating and immobilizing the polyethylene glycol derivative on the gold thin-film layer by the chemical bonding of sulfur and gold. The thickness of the gold thin-film layer is desirably 10 nm or larger due to the requirement that a surface of a foundation layer be completely covered with the gold thin-film layer. The above-described method of surface treatment is also applicable to complicated shapes and is suitable for the treatment of nozzles.

FIG. 2 illustrates a cross-sectional view taken along a dotted line in FIG. 1 with respect to a treated portion of the pipetting nozzle treated in this way. Reference numeral 111 denotes a pipetting nozzle main unit and the pipetting nozzle main unit is made of stainless steel or the like. Reference numeral 112 denotes a gold thin-film layer formed on the pipetting nozzle main unit 111 by means of electroplating or electroless plating. Although a case is shown here in which plating is directly performed on stainless steel, nickel or the like may be plated first on stainless steel, and then gold plating may be performed thereon. Reference numeral 113 denotes a layer of the polyethylene glycol derivative chemically bonded to the gold thin-film layer 112. The layer serves to inhibit the adsorption of biological polymers, such as protein. Reference numeral 114 denotes a hollow portion of the pipetting nozzle. The pipetting nozzle is cleaned by performing an alcohol or UV/excimer treatment on the gold thin-film layer formed by electroplating or electroless plating. Thereafter, the pipetting nozzle is immersed for an adequate amount of time in a solution of the polyethylene glycol derivative having a thiol group at one terminal thereof. From the results of XPS measurement of S2p (sulfur 2p), the inventors have been able to confirm that sulfur exists in a state of sulfur-metal chemical bonds on a surface treated in this way.

The effect of adsorption inhibition was verified by measuring the adsorbed amount of protein by means of XPS. Specifically, the adsorbed amount of BSA (bovine serum albumin) was estimated from the peak area of N1s (nitrogen 1s) XPS. BSA is suitable as a model of serum albumin which accounts for approximately 50 to 65% of serum protein. In a substrate in which the above-described surface treatment was performed, it was confirmed that the peak area of N1s fell below a detection minimum even after a BSA sorption experiment was conducted. Thus, a significant difference of the above-described pipetting nozzle was recognized from a conventional stainless steel nozzle or a nozzle in which a gold thin-film layer was formed on stainless steel.

In the above-described surface treatment method, it is possible to adsorb molecules to the gold thin-film layer to an extremely small thickness, for example, in the form of a monomolecular film. This is because molecules adsorb onto a surface through sulfur atoms and, after the formation of a monomolecular layer is completed, can no longer chemisorb onto the surface. Such a phenomenon has been confirmed by experiments based on, for example,) XPS or spectroscopic ellipsometry. An electrical measurement method in which a change in the electrostatic capacity of a pipetting nozzle is used as an indicator is widely used when a liquid level is detected by the pipetting nozzle. In that case, it is desirable that a surface of the pipetting nozzle is electrically conductive. If a layer of the polyethylene glycol derivative is thick and highly electrically insulating, this electrical measurement method is not valid. On the other hand, the electrical conductivity of the nozzle's surface can be maintained if the layer of the polyethylene glycol derivative is a monomolecular film. Consequently, the above-described method is advantageous in that a method using electrostatic capacity can still be utilized at the time of liquid level detection even after surface treatment.

If any mechanical damage is applied to the nozzle surface, the polyethylene glycol derivative chemisorbed onto the nozzle surface may fall away in some cases. In the above-described surface treatment method, the polyethylene glycol derivative can be chemisorbed in a simple and convenient manner. Accordingly, a mechanism for chemisorbing the polyethylene glycol derivative can be assembled into an autoanalyzer. Thus, it is possible to solve the problem of fall away.

### Advantageous Effects of Invention

According to the present invention, it is possible to fabricate a pipetting nozzle onto a surface of which a polyethylene glycol derivative is chemisorbed and coated, and inhibit the adsorption of biological polymers, such as protein. Consequently, it is possible to reduce carry-over during dispensing operation, thereby enhancing the analytical reliability of an autoanalyzer. In addition, these advantages contribute to reductions in the amounts of samples and reagents used, and to a reduction in the running cost of the autoanalyzer.

### BRIEF DESCRIPTION OF DRAWINGS

FIG. 1 is a schematic view of a pipetting nozzle.

FIG. 2 is a cross-sectional view of a surface-treated portion of the pipetting nozzle.

FIG. 3 is a surface treatment process flowchart of the pipetting nozzle.

FIG. 4 is a drawing showing results of XPS.

FIG. 5 is a drawing showing results of XPS.

FIG. 6 is a drawing showing results of XPS.

FIG. 7 is a schematic view illustrating a configuration example of an autoanalyzer.

FIG. 8 is a schematic view illustrating a configuration example of an autoanalyzer including a mechanism for performing surface treatment.

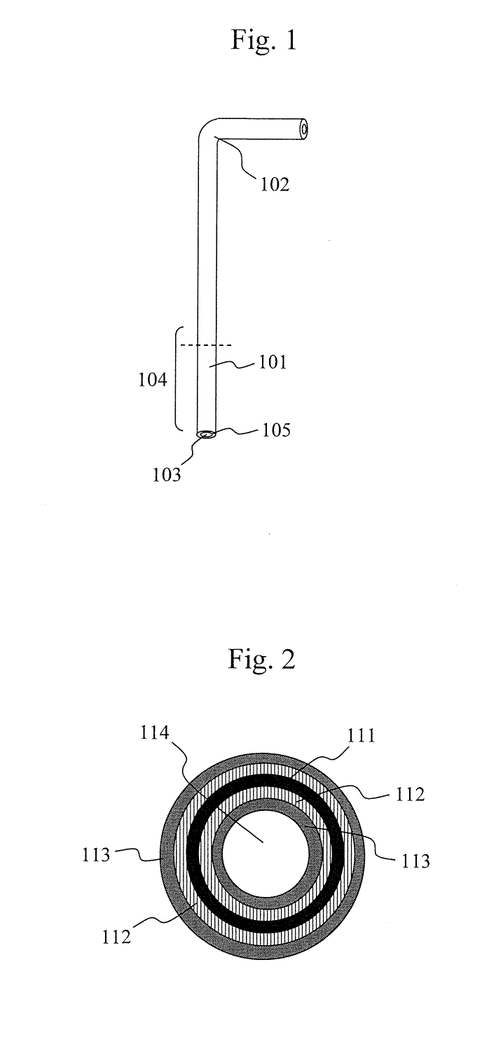

### DESCRIPTION OF EMBODIMENTS

Next, the present invention will be described in more detail according to embodiments, but is not limited to the embodiments to be described hereinafter.

### EXPERIMENTAL EXAMPLE

First, in order to enhance the reliability of analysis, a planar substrate was used to verify effectiveness. The size of the substrate used was 10 mm×10 mm×0.5 mm, and a 10 mm×10 mm surface was used as a measuring surface for effectiveness verification.

(Fabrication of Substrate to which Polyethylene Glycol Derivative is Adsorbed)

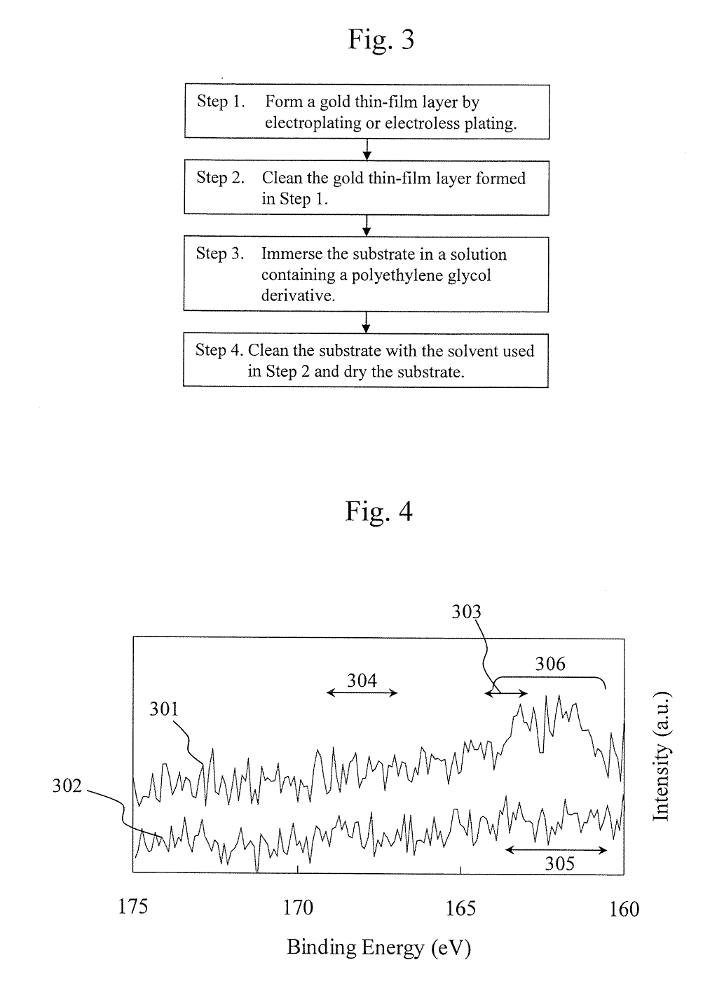

FIG. 3 shows a process flow of an experiment.

Step 1. Form a gold thin-film layer by electroplating or electroless plating.

Specifically, electrolytic gold plating was performed on a stainless steel substrate. First, in order to remove grease remaining on stainless-steel surfaces, the surfaces were degreased with an alkaline solvent. Subsequently, the stainless-steel substrate was immersed in an acidic activation bath to activate substrate surfaces. A solution composed of potassium gold cyanide, cobalt sulfate, and citric acid monohydrate was used as a plating solution to perform gold plating. Treatment time, solution temperature, pH and current density were optimized so that a film thickness was 0.1 μm. In addition to electroplating, electroless plating may be used.

Step 2. Clean the gold thin-film layer formed in step 1.

Specifically, the substrate was ultrasonic-cleaned with ethanol for 15 minutes, and then UV/excimer-treated for 5 minutes. Under this condition, a contact angle of water was measured using Drop Master 500 made by Kyowa Interface Science. 0.5 μL of pure water was dropped on the substrate by using a syringe and static contact angles one second after droplet deposition was measured by a three-point method. As a result, the contact angle of the substrate was 5±1°. This confirmed that the surface was clean.

Step 3. Immerse the substrate in a solution containing a polyethylene glycol derivative.

Specifically, the substrate cleaning-treated as described above was immersed in a 2 mM ethanol solution of 11-Mercaptoundecanol hexaethylene glycol ether and left at rest for 24 hours. The chemical formula of 11-Mercaptoundecanol hexaethylene glycol ether is shown below:

HS—(CH₂)₁₁—(OCH₂CH₂)₆—OH

Step 4. Clean the substrate with the solvent used in step 2 and dry the substrate.

Specifically, after being taken out of the solution, the substrate was fully cleaned with ethanol, thereby rinsing off excess 11-Mercaptoundecanol hexaethylene glycol ether remaining on the surface. Thereafter, the substrate was dried by nitrogen blowing.

In order to verify the effect of surface treatment according to the present invention, the following two substrates were prepared as reference substrates.

(Reference Substrate 1. Fabrication of Substrate Subjected to Gold Plating Only)

First, a description will be given of the treatment procedure of a first reference substrate. An electrolytic gold plating was performed on a stainless-steel substrate. A film thickness was set to 0.1 μm. Next, this substrate was ultrasonic-cleaned with ethanol for 15 minutes, and then UV/excimer-treated for 5 minutes. Under this condition, a contact angle of water was measured by the same method as described above. As a result, the contact angle of the substrate against water was 5±1°. This confirmed that the surface was clean.

Next, the substrate cleaning-treated as described above was immersed in ethanol and left at rest for 24 hours. After being gently taken out of the solution, the substrate was dried with nitrogen. This substrate subjected to gold plating only was specified as the first reference substrate.

(Reference Substrate 2. Fabrication of Stainless-Steel Substrate)

For a second reference substrate, a stainless-steel substrate was ultrasonic-cleaned with a 1% NaOH solution for 15 minutes, and then also ultrasonic-cleaned with ethanol for 15 minutes. This cleaning-treated stainless-steel substrate was specified as the second reference substrate.

The effect of inhibiting the adsorption of biological polymers was verified by a test of BSA adsorption. First, a 2.5 g/L solution of BSA was prepared. As a solvent, Dulbecco's phosphate buffer solution was used. The prepared substrate was immersed for 30 minutes in the solution thus made up. After being taken up, the substrate was first fully cleaned with Dulbecco's phosphate buffer solution. Next, the substrate was fully cleaned with pure water. Finally, the substrate was dried by nitrogen blowing.

The three substrates fabricated as described above were XPS-measured to conduct a quantification analysis on surface compositions. The XPS measurement was made using Quantera SXM made by PHI. As an X-ray source, a monochromatic Al (1486.6 eV) was used. A detection region was set to 100 μmφ, and a takeoff angle was set to 45°.

As the result of measurement based on wide scan (bond energy: 0 to 1275 eV, energy step: 1.0 eV), Fe (iron) and Cr (chromium) were detected from the stainless-steel substrate. However, Au (gold) was only the metal element detected from the two gold-plated substrates and neither Fe nor Cr was detected. This confirmed that surfaces of both of the two gold-plated substrates were coated with gold.

In order to study a bonding state of sulfur in a substrate immersed in a solution of 11-Mercaptoundecanol hexaethylene glycol ether molecules, a narrow scan of S2p was measured over a bond energy range of 160 eV to 175 eV in energy steps of 0.1 eV. FIG. 4 shows measurement results. Reference numeral 301 denotes a spectrum of a substrate subjected to both a gold-plating treatment and a treatment of immersion in the 11-Mercaptoundecanol hexaethylene glycol ether. Reference numeral 302 denotes a spectrum of the substrate subjected to a gold-plating treatment only. A range shown by an arrow 303 is where C—S bonds (carbon-sulfur bonds) are detected, a range shown by an arrow 304 is where SO₄ is detected, and a range shown by an arrow 305 is where metal-S bonds (metal-sulfur bonds) are detected. The spectrum 301 was measured as a spectrum having a peak 306 near a bond energy of 162 eV. This indicates that the bonding state of sulfur is a metal-sulfur bond. Since only gold was detected as a metal element as the result of the wide scan, the bond is a gold-sulfur bond. This showed that an S—H bond of 11-Mercaptoundecanol hexaethylene glycol ether molecules cleaved into a thiolate and chemisorbed in the gold. In an XPS spectrum 302 of the reference substrate 1 subjected to gold plating only, sulfur was less than a detection minimum.

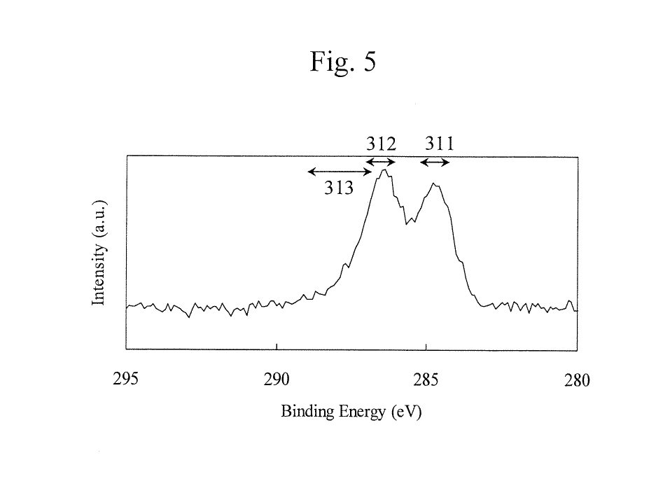

In order to study a bonding state of carbon, a narrow scan of C1s (carbon 1s) was measured over a bond energy range of 278 eV to 296 eV in energy steps of 0.1 eV. FIG. 5 shows results of measurement performed on a substrate immersed in a solution of thiol (11-Mercaptoundecanol hexaethylene glycol ether). A range shown by an arrow 311 is where C—C and C—H bonds are detected, a range shown by an arrow 312 is where C—O bonds are detected, and a range shown by an arrow 313 is where C═O, O═C—O and CO₃ bonds are detected. As shown in FIG. 5, a peak attributable to C—O bonds was observed with high intensity, in addition to a peak due to C—C and C—H bonds. This observation reflects C—O bonds within the 11-Mercaptoundecanol hexaethylene glycol ether molecules. In other two reference substrates, only a peak derived from C—C and C—H bonds was detected.

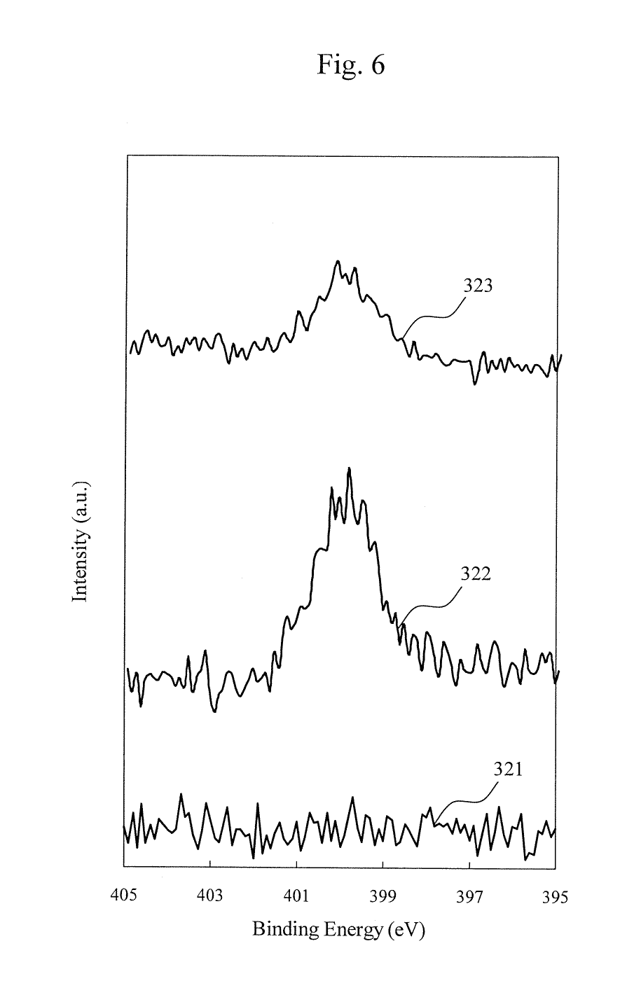

Next, a description will be given of the comparison of substrate-by-substrate adsorbed amounts of BSA (bovine serum albumin). There is an example of XPS-based study on the adsorption of BSA to a stainless-steel surface (Non-Patent Literature 2). Accordingly, quantification analysis of the adsorption is possible based on an N1s peak corresponding to nitrogen atoms (N) in BSA. Here, the N1s peak is attributable to amine and amide contained in BSA. Hence, in the present embodiment, substrate-by-substrate relative adsorbed amounts of BSA were quantified by N1s XPS to verify inhibition effects on protein adsorption onto a substrate surface. FIG. 6 shows verification results. Reference numeral 321 denotes a spectrum of a substrate subjected to both a gold-plating treatment and a treatment of immersion in the 11-Mercaptoundecanol hexaethylene glycol ether. Reference numeral 322 denotes a spectrum of a substrate subjected to a gold-plating treatment only. Reference numeral 323 denotes a spectrum of a stainless-steel substrate. A spectrum having a symmetrical N1s peak near a bond energy of 400 eV was observed on a surface subjected to gold plating only and onto which BSA adsorbed, and on a stainless-steel surface.

The analysis of an N1s peak area was conducted by linearly subtracting a background over the range of 395 eV to 405 eV. Table 1 shows relative peak areas when an N1s peak area on the surface subjected to gold plating only is defined as 1.0. In Table 1, the substrate immersed in the 11-Mercaptoundecanol hexaethylene glycol ether solution is designated as a thiol solution-immersed substrate, the substrate subjected to gold plating only is designated as a gold-plated substrate, and the stainless-steel substrate is literally designated as a stainless-steel substrate.

TABLE 1

| | N1s Peak Area Ratio |
|---|---|
| | (Only gold-plated substrate is defined |
| Substrate | as 1.0) |
| (1) Thiol solution-immersed | Less than detection minimum |
| substrate (321) | |
| (2) Gold-plated substrate (322) | 1.0 |
| (3) Stainless-steel substrate (323) | 0.46 |

Peak area ratios when the N1s peak area of the gold-plated substrate is defined as 1.0 are 0.46 for the stainless-steel substrate and less than a detection minimum for the thiol solution-immersed substrate. If a detection minimum (0.1% in terms of nitrogen content) in this measurement is taken into consideration, the adsorbed amount of BSA is no more than 2% in the case of the thiol solution-immersed substrate, compared with the gold-plated substrate. Thus, it has been confirmed that the thiol solution-immersed substrate can better inhibit the adsorption of BSA, compared with the substrate subjected to gold plating only and the stainless-steel substrate.

From the above-described results, it has been shown that the adsorption of biological polymers as typified by protein onto surfaces of a pipetting nozzle is significantly inhibited by performing gold plating on stainless steel and adsorbing 11-Mercaptoundecanol hexaethylene glycol ether molecules thereonto. This predicts that it is possible to reduce carry-overs remaining on surfaces of the pipetting nozzle.

Although in the foregoing, 11-Mercaptoundecanol hexaethylene glycol ether is used as the polyethylene glycol derivative, similar effects have been attained with the compounds mentioned below:

HS—(CH₂)₁₁—(OCH₂CH₂)₂—OH

HS—(CH₂)₁₁—(OCH₂CH₂)₄—OH

HS—(CH₂)₁₁—(OCH₂CH₂)₁₇—OH

HS—(CH₂)₁₁—(OCH₂CH₂)₆—OCH₃

The methylene group (CH₂)₁₁ may be generally a hydrocarbon group. In general, similar effects can be attained with compounds given by General Formula 1 shown below:

HS—R1—(OCH₂CH₂)ₙ—O—R₂ (General Formula 1)

(n is a positive integer equal to or larger than 2, R₁ is a hydrocarbon group, and R₂ is H or CH₃)

H or CH₃ is suitable as R₂ from the viewpoint of hydrophilicity. Due to the requirement that the necessary number of ethylene oxide groups be 2 or larger and that molecular interaction for molecules to become arrayed be sufficient, the number average molecular weight of a polyethylene glycol derivative is desirably 100 or higher. Conversely, if an intermolecular steric repulsive force is too strong, the amount of polyethylene glycol derivative adsorbed onto a surface reduces. Accordingly, the number average molecular weight of the polyethylene glycol derivative is desirably 20000 or lower. The chemical structure of the polyethylene glycol derivative to coat surfaces with need not necessarily be a unitary structure but may be an intermixture.

### Embodiment 1

In the present embodiment, a description will be given of a case in which the same treatment as that in the experimental example is performed on a pipetting nozzle. First, a gold thin-film layer was formed on a surface of a stainless-steel pipetting nozzle in the same way as in the experimental example. Areas to be treated were specified as the edge portion 105 of the pipetting nozzle illustrated in FIG. 1 and the nozzle's area 104 to be immersed in a sample. In the present embodiment, the outer diameter of the treated nozzle tip was 0.5 mm and the inner diameter thereof was 0.3 mm. A gold thin-film layer was formed by electroplating across a 10 mm area of the nozzle tip. It is also possible to treat the entire surface of the pipetting nozzle. By limiting the areas to be treated to portions to be immersed, however, costs can be reduced.

Next, a surface on which the gold thin-film layer was formed by electroplating was ultrasonic-cleaned with ethanol for 15 minutes. At this time, a configuration was adopted in which a support base was provided to prevent the nozzle from coming into contact with a vessel, so that the nozzle might not become damaged by ultrasonic waves. Thereafter, a UV/excimer cleaning treatment was performed. The entire range of areas in need of treatment was treated by cleanup-treating the pipetting nozzle, while rotating the nozzle, so as not to give rise to areas not irradiated with UV light.

The pipetting nozzle through with the cleanup treatment was immersed in a solution of a polyethylene glycol derivative. As the polyethylene glycol derivative, it is possible to use a solution of at least one molecule selected from the group consisting of 11-Mercaptoundecanol hexaethylene glycol ether and a series of molecules represented by General Formula 1 in the experimental example. Here, the pipetting nozzle was immersed in a 2 mM ethanol solution of 11-Mercaptoundecanol hexaethylene glycol ether for 24 hours. Thereafter, the nozzle was rinsed with a solvent, such as ethanol, and then dried by nitrogen blowing.

For effectiveness verification, the amount of BSA remaining on a surface was measured by XPS in the same way as in the experimental example. As a result, it was confirmed that the amount of protein remaining on the surface of the pipetting nozzle after dispensation was reduced to 1/20 or less (less than the detection minimum of XPS measurement discussed in the experimental example), compared with a conventional stainless-steel nozzle.

### Embodiment 2

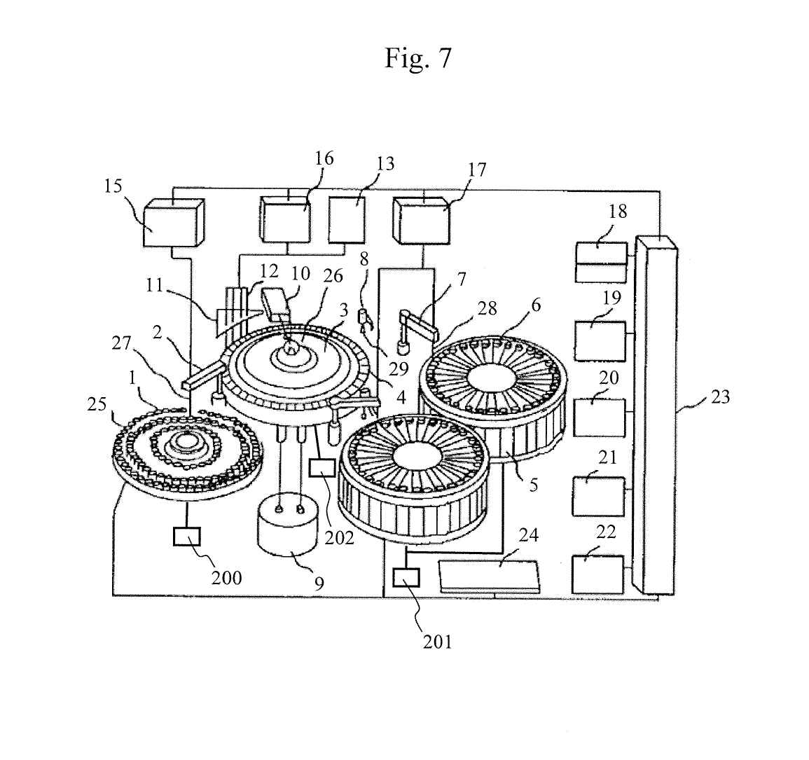

FIG. 7 is a drawing illustrating a configuration example of an autoanalyzer according to the present invention. The basic operation of the autoanalyzer will be described next. One or more sample containers 25 are disposed in a sample storage mechanism 1. Here, a description will be given by taking as an example a sample disk mechanism which is a sample storage mechanism mounted on a disk-like mechanism. Alternatively, the sample storage mechanism may be in other forms, for example, in the form of a sample rack or a sample holder commonly used in autoanalyzers. In addition, the term “sample” as referred to herein refers to a solution under test to be used for reaction in a reaction container. The sample may be a concentrate solution of a collected sample, or a solution prepared by applying processing treatment, such as dilution or pretreatment, to the concentrate solution. A sample in a sample container 25 is taken up by a sample pipetting nozzle 27 of a pipetting mechanism for sample supply 2 and injected into a predetermined reaction container. The sample pipetting nozzle was surface-treated with 11-Mercaptoundecanol hexaethylene glycol ether by the method described in Embodiment 1. A reagent disk mechanism 5 is provided with a multitude of reagent containers 6. In addition, a pipetting mechanism for reagent supply 7 is arranged in the mechanism 5. A reagent is suctioned by a reagent pipetting nozzle 28 of this mechanism 7, and injected into a predetermined reaction cell. Reference numeral 10 denotes a spectral photometer and reference numeral 26 denotes a light source with a condensing filter. A reaction disk 3 for housing measuring objects is located between the spectral photometer 10 and the light source with a condensing filter 26. 120 reaction cells 4, for example, are disposed on an outer circumference of this reaction disk 3. In addition, the whole of the reaction disk 3 is maintained at a predetermined temperature by a thermostatic chamber 9. Reference numeral 11 denotes a reaction cell cleaning mechanism, and a cleaning agent is supplied from a cleaning agent container 13. Suction from within a cell is undertaken by a suction nozzle 12.

Reference numeral 19 denotes a computer, reference numeral 23 denotes an interface, reference numeral 18 denotes a logarithmic converter and an A/D converter, reference numeral 17 denotes a pipetter for reagents, reference numeral 16 denotes a rinse water pump, and reference numeral 15 denotes a pipetter for samples. In addition, reference numeral 20 denotes a printer, reference numeral 21 denotes a CRT, reference numeral 22 denotes a floppy disk or a hard disk as a storage device, and reference numeral 24 denotes an operating panel. The sample disk mechanism, the reagent disk mechanism, and the reaction disk are controlled and driven through the interface by a driving unit 200, a driving unit 201, and a driving unit 202, respectively. In addition, respective units of the autoanalyzer are controlled by the computer 19 through the interface.

In the above-described configuration, an operator inputs analysis request information by using the operating panel 24. The analysis request information input by the operator is stored in a memory within the microcomputer 19. A sample to be measured put in a sample container 25 and set in a predetermined position of the sample disk housing mechanism 1 is dispensed into a reaction cell in predetermined amounts, according to the analysis request information stored in the memory of the microcomputer 19, by the sample pipetter 15 and the surface-treated sample pipetting nozzle 27 of the pipetting mechanism for sample supply 2. The surface-treated sample pipetting nozzle 27 is rinsed with water and used for the dispensation of the next sample.

At this time, it is possible to inhibit the adsorption of biological polymers as typified by protein by using the sample pipetting nozzle 27 coated with 11-Mercaptoundecanol hexaethylene glycol ether. Thus, it is possible to reduce sample-to-sample carry-over, compared with a conventional stainless-steel pipetting nozzle. In addition, since the 11-Mercaptoundecanol hexaethylene glycol ether forms a monomolecular film at this time, a liquid level can be detected by means of a change in electrostatic capacity. A predetermined amount of reagent is dispensed into a reaction cell by the reagent pipetting nozzle 28 of the pipetting mechanism for reagent supply 7. The reagent pipetting nozzle 28, after being rinsed with water, dispenses a reagent for the next reaction cell. A mixed solution of a sample and a reagent is agitated by a stirring bar 29 of an agitation mechanism 8. The agitation mechanism 8 sequentially agitates mixed solutions of the next and subsequent reaction cells.

For the surface treatment of the sample pipetting nozzle 27, it is possible to use at least a solution of one molecule selected from the group consisting of a series of molecules represented by General Formula 1 in the experimental example, in addition to the 11-Mercaptoundecanol hexaethylene glycol ether.

### Embodiment 3

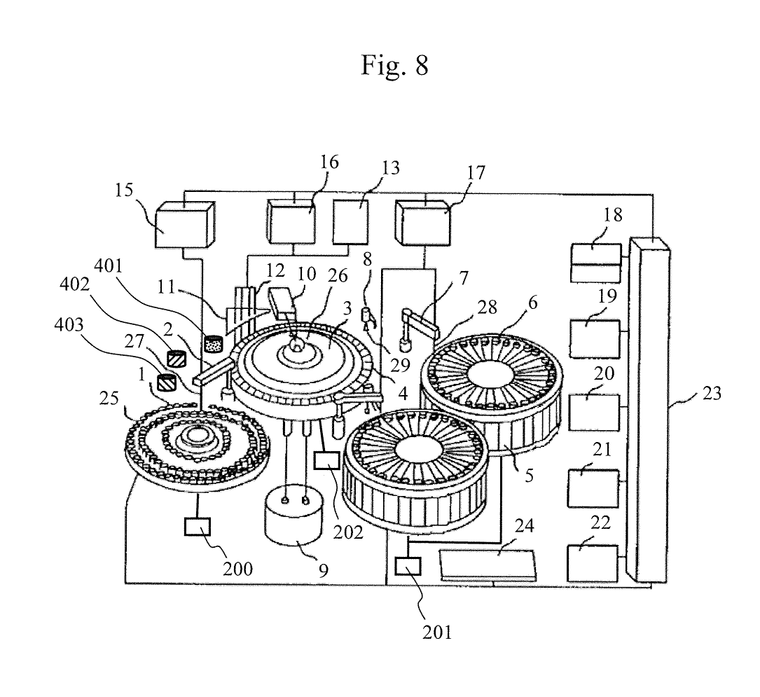

FIG. 8 illustrates a schematic view of an autoanalyzer used in the present embodiment. First, a sample pipetting nozzle 27 is rotationally moved to a first treatment liquid tank 401, lowered, and immersed in a first treatment liquid. An area of immersion at this time is sufficiently larger than an area of the sample pipetting nozzle 27 immersed in a sample at the time of dispensation. As the first treatment liquid, it is possible to use a solution of at least one molecule selected from the group consisting of 11-Mercaptoundecanol hexaethylene glycol ether and a series of molecules represented by General Formula 1 in the experimental example, as a polyethylene glycol derivative. Here, a 2 mM ethanol solution of 11-Mercaptoundecanol hexaethylene glycol ether was used. An immersion time varies depending on the frequency of immersion. For example, an immersion time of one second or so is sufficient if the nozzle is immersed at each time of dispensation. Alternatively, the nozzle may be kept immersed for about 24 hours if the nozzle is immersed after the end of a day's analysis work. Next, the sample pipetting nozzle 27 is rotationally moved to a second treatment liquid tank 402, lowered, and immersed in a second treatment liquid. At this time, an area of immersion is sufficiently larger than the abovementioned area immersed in the first treatment liquid. As a solution used with the second treatment liquid tank 402, ethanol which is used as a solvent of the treatment liquid of the abovementioned first treatment liquid tank 401 is used.

By the above-described operation in the second treatment liquid tank 402, it is possible to remove 11-Mercaptoundecanol hexaethylene glycol ether excessively attached to the nozzle when the nozzle is treated in the first treatment liquid tank 401. By dispensing a sample thereafter, it is possible to inhibit the adsorption of biological polymers as typified by protein and reduce carry-overs to a half or less, compared with a conventional stainless-steel pipetting nozzle.

Also in Embodiments 1 to 3 described above, the number average molecular weight of a polyethylene glycol derivative is desirably 100 or higher, as in the experimental example, due to the requirement that the necessary number of ethylene oxide groups be 2 or larger and that molecular interaction for molecules to become arrayed be sufficient. Conversely, if an intermolecular steric repulsive force is too strong, the amount of polyethylene glycol derivative adsorbed onto a surface reduces. Accordingly, the number average molecular weight of the polyethylene glycol derivative is desirably 20000 or lower. The chemical structure of the polyethylene glycol derivative to coat surfaces with need not necessarily be a unitary structure but may be an intermixture.

Although in the above-described embodiments, discussions have been made on carry-over in a pipetting nozzle, the same advantageous effects can be attained by applying treatments of the present invention to every member, including an stirring bar, which can be a cause for carry-over.

According to the present invention, it is possible to dramatically reduce the nonspecific adsorption of biological polymers, such as protein, onto surfaces of a pipetting nozzle, thereby inhibiting carry-over and contributing to enhancing the reliability of an autoanalyzer. Consequently, the present invention can also contribute to reductions in the amounts of samples and reagents, thereby reducing running costs and environmental burdens.

### REFERENCE SIGNS LIST

1 Sample storage mechanism
2 Pipetting mechanism for sample supply
3 Reaction disk
4 Reaction cell
5 Reagent disk mechanism
6 Reagent container
7 Pipetting mechanism for reagent supply
8 Agitation mechanism
9 Thermostatic chamber
10 Spectral photometer
11 Reaction cell cleaning mechanism
12 Suction nozzle
13 Cleaning agent container
15 Sample pipetter
16 Rinse water pump
17 Reagent pipetter
25 Sample container
26 Light source with condensing filter
27 Sample pipetting nozzle
28 Reagent pipetting nozzle
29 Stirring bar
101 Pipetting nozzle main unit
102 Bent portion of pipetting nozzle
103 Hollow portion of pipetting nozzle
111 Pipetting nozzle main unit
112 Gold thin-film layer
113 Hydrophilic molecular layer
114 Hollow portion of pipetting nozzle
200 Driving unit
201 Driving unit
202 Driving unit
401 First treatment liquid tank
402 Second treatment liquid tank
403 Pipetting nozzle cleaning tank

1-9. (canceled)

10. An autoanalyzer comprising:
a plurality of sample containers each storing a sample;
a plurality of reagent containers each storing a reagent;
a plurality of reaction cells into which samples and reagents are injected;
a sample pipetting mechanism for injecting samples in the sample containers into the reaction cells; and
a reagent pipetting mechanism for injecting reagents in the reagent containers into the reaction cells,
wherein the sample pipetting mechanism is provided with a pipetting nozzle, the pipetting nozzle is a conductive nozzle formed of a conductive material, a surface of the conductive nozzle being coated with an organic monomolecular film, and a liquid level is detected by detecting a change in electrostatic capacity through the organic monomolecular film of the pipetting nozzle.

11. The autoanalyzer according to claim 10, wherein the organic monomolecular film is formed of a polyethylene glycol derivative.

12. The autoanalyzer according to claim 11, wherein an area of the pipetting nozzle to which the polyethylene glycol derivative is chemisorbed is larger than an area of the pipetting nozzle immersed in a sample at the time of dispensation.

13. The autoanalyzer according to claim 11, further comprising a mechanism for performing a surface treatment to chemisorb the polyethylene glycol derivative to the pipetting nozzle.

14. The autoanalyzer according to any one of claims 11 to 13, wherein the pipetting nozzle has a gold thin-film layer on a surface of the conductive nozzle, and the polyethylene glycol derivative having a thiol group at one terminal thereof and represented by the following general formula is chemisorbed to the gold thin-film layer:
HS—R₁—(OCH₂CH₂)ₙ—O—R₂ (n is a positive integer equal to or larger than 2, R₁ is a bivalent hydrocarbon group, and R₂ is H or CH₃).

15. The autoanalyzer according to claim 14, wherein the conductive nozzle is a nozzle in which the gold thin-film layer is formed on stainless steel by electroplating or electroless plating.

16. A pipetting nozzle for an autoanalyzer used in an autoanalyzer for injecting a sample in a sample container into a reaction cell by using a nozzle and detecting a liquid level by detecting a change in electrostatic capacity by using a nozzle, wherein the pipetting nozzle is a conductive nozzle formed of a conductive material, a surface of the conductive nozzle being coated with an organic monomolecular film.

17. The pipetting nozzle for an autoanalyzer according to claim 16, wherein the organic monomolecular film is a polyethylene glycol derivative chemisorbing to a surface and having a number average molecular weight of 100 to 20000.

18. The pipetting nozzle for an autoanalyzer according to claim 17, wherein the polyethylene glycol derivative is represented by the following general formula:
HS—R₁—(OCH₂CH₂)ₙ—O—R₂ (n is a positive integer equal to or larger than 2, R₁ is a hydrocarbon group, and R₂ is H or CH₃).

19. A method for manufacturing a pipetting nozzle for an autoanalyzer used to inject a sample in a sample container into a reaction cell, the method comprising the steps of:
forming a gold thin-film layer on a surface of the pipetting nozzle by electroplating or electroless plating;
cleaning the gold thin-film layer with ethanol, and then cleaning the gold thin-film layer by a UV/excimer treatment;
immersing the cleaned pipetting nozzle in a solution of a polyethylene glycol derivative having a number average molecular weight of 100 to 20000 and represented by the following general formula:
HS—R₁—(OCH₂CH₂)ₙ—O—R₂ (n is a positive integer equal to or larger than 2, R₁ is a bivalent hydrocarbon group, and R₂ is H or CH₃);
cleaning a treated surface of the pipetting nozzle with a solvent; and
drying the surface.
